(19) United States
(12) Patent Application Publication
(10) Pub. No.: US 2010/0010925 A1
(43) Pub. Date: Jan. 14, 2010

(54) Method of exchanging securities

(76) Inventor: Jacob Wohlstadter, Rockville, MD (US)

Correspondence Address: WOLF GREENFIELD & SACKS, P.C., 600 ATLANTIC AVENUE, BOSTON, MA, 02210-2206, US

(21) Appl. No.: 12/322,177

(22) Filed: Jan. 29, 2009

Related U.S. Application Data
(63) Continuation of application No. 09/698,586, filed on Oct. 27, 2000, now abandoned.
(60) Provisional application No. 60/163,739, filed on Oct. 29, 1999.

(51) Int. Cl. G06Q 40/00

(52) U.S. Cl. 705/37

(57) ABSTRACT

A method of conducting transactions in securities provides an economic benefit to the issuing entity whenever a security issued by the entity is involved in a transaction. For example, an entity issuing stock may receive a royalty whenever the stock is traded between third parties on a stock exchange. A computer system or computer program running on a computer system forming a computerized exchange may be provided to enable transactions in securities and to calculate royalties payable to the issuing entity for transactions involving securities issued by that entity. The royalty may take the form of any measure of economic benefit to the issuing entity or of economic detriment to one of the other parties or intermediaries involved in the transaction. For example, the value may include a percentage of the seller's profit, a percentage of the value of the securities involved in the transaction, a percentage of the number of securities involved in the transaction, a portion of the security itself, a right to buy other securities, a straight fee, a commission, a portion of a spread between the sales price and bid price, a portion of a fee due to the exchange on which the transaction took place, a portion of a fee due to any intermediary, or any other measure of value. Royalties may due to the entity for every transaction, every predetermined number of transactions, various sets or subsets of transactions, randomly selected transactions, transactions involving only particular securities or for any other subset of transactions.

### FIELD OF THE INVENTION

The present invention relates to a method and apparatus for conducting transactions in securities (as defined below) and, more particularly, to a method and apparatus for conducting transactions in securities while returning a portion of the proceeds generated by that transaction to the entity issuing the security.

### BACKGROUND OF THE INVENTION

The American investment system, and indeed much of the international investment system, is fundamentally derived from the ability of individuals and commercial organizations to buy and sell instruments representing financial interests in other commercial organizations or institutions (entities) such as businesses, mutual funds, etc. The underlying goal of participants in this investment system, for investors, is to buy the instrument at a low price, hold it for a period of time, sell the instrument at a higher price, and realize the difference between purchase price and sale price as profit. Of course, taxes, commissions, etc., may reduce the amount of profit for any one transaction. Likewise, not all instruments appreciate in value over time, and a subsequent sale of the instrument may result in a loss to the original purchaser. The inventions set forth herein relate to variations in this basic investment system.

The following definitions are set forth to clarify the meaning of particular terms that will be used throughout this specification and claims. Non-defined terms may be interpreted according to their use in context and their customary meaning to one of skill in the art, for example as defined in Section 3 of the Securities Exchange Act of 1934.

As used herein, the term “transaction” shall include a trade, sale, lease, transfer for value, gift, or other disposition of a security (defined below). The terms “sale” and “sell” each include any contract to sell or otherwise dispose of. Likewise, the terms “buy” and “purchase” each include any contract to buy, purchase, or otherwise acquire. Transactions may be directly consummated between participants or may be intermediated (discussed below).

Typical transactions may involve financial instruments referred to as securities, As used herein, the term “security” includes any note, stock, bond, debenture, or in general, any instrument commonly known as a “security,” but does not include any instrument of a governmental entity, such as a bond, that is also subject to taxation by that same governmental entity. For example, the term “security” may include: (a) a certificate of interest or participation in any profit-sharing agreement or in any oil, gas, or other mineral royalty or lease; (b) a collateral-trust certificate, preorganization certificate or subscription, transferable share, investment contract, voting-trust certificate, or certificate of deposit for a security; (c) a put, call, straddle, option, or privilege on any security, certificate of deposit, or group or index of securities; (d) a stock or similar security; or any security, convertible, with or without consideration, into such a security, or carrying any warrant or right to subscribe to or purchase such a security; and (e) a certificate of interest or participation in, temporary or interim certificate for, receipt for, or warrant or right to subscribe to or purchase, any of the foregoing. While this list is extensive, it is not intended to be exhaustive, and the term “security” therefore shall also be interpreted to include, in general, any instrument commonly known as a “security.” The term “security” thus encompass numerous investment vehicles that may or may not be regulated by a governmental entity, and that may be publicly or privately tradeable.

Securities are generally issued by a corporation, partnership, limited liability company, limited liability partnership, trust, labor group, union, mutual fund, an individual or group of individuals with assets or which are capable of providing goods or services, or any other type of business. As used herein, the term “entity” will refer to the issuer (i.e., issuing body) of the security regardless of the form in which the issuer is organized. The term “issuer” includes any person who issues or proposes to issue any security.

An intermediated transaction between two or more participants takes place with the assistance or oversight by a third-party, the intermediary. In an intermediated transaction, participants may communicate directly or may communicate (and consummate a transaction) indirectly through one or more third-party intermediaries.

As used herein, the term intermediary shall be broadly construed to include an exchange, computerized exchange, member of an exchange, broker, dealer, market maker, specialist, person associated with any of these entities, or any other entity that performs the functions of an intermediary. An intermediary may be human or computerized.

An “exchange” includes any individual, organization, association, or group of persons, whether incorporated or unincorporated, that constitutes, maintains, or provides a market place or facilities, such as a physical marketplace, computer system, or computer network, for bringing together participants to transactions, such as purchasers and sellers of securities, or for otherwise performing, with respect to securities, the functions commonly performed by a stock exchange as that term is generally understood, and includes the facilities maintained by such exchange. A computerized exchange includes any exchange, the implementation of which is at least partially performed by a computer, including but not limited to an exchange that uses a computer configured to receive input from participants wishing to conduct transactions in securities or that is otherwise configured to provide intermediary services. Various specific examples of computerized exchanges are set forth below. The term computerized exchange is not limited to these specific examples.

The “rules” of an exchange includes the constitution, articles of incorporation, bylaws, and rules, or instruments corresponding to the foregoing, of an exchange, as well as the stated policies, practices, and interpretations of such rules.

Membership on an exchange is typically governed by the rules of the particular exchange. Thus, the term “member” may vary widely from exchange to exchange. In a typical exchange, a member of an exchange includes any person permitted to effect transactions on the exchange, without the services of another person acting as broker, or any computer acting in such fashion. Members typically are allowed to appoint representatives to conduct transactions on the exchange.

A “broker” includes any person engaged in the business of effecting transactions in securities for the account of others, or any computer acting in such fashion. A “dealer” is any person engaged in the business of effecting transaction in securities for its own account, through a broker or otherwise, or any computer acting in such fashion.

There are several well known examples of intermediaries that are involved mainly with trading securities commonly referred to as stocks and options. The particular intermediary to be used may differ, depending on the status of the securities as listed or unlisted. Unlisted securities are also known as over-the-counter (“OTC”) securities.

Listed stocks and options can be traded on securities exchanges such as the New York Stock Exchange (“NYSE”), the American Stock Exchange (“ASE”), the Chicago Board of Options Exchange (“CBOE”), and various other exchanges in the United States and other countries.

Over-the-counter securities can be traded on a computer network, such as the National Association of Securities Dealers Automatic Quotation system (“NASDAQ”). The NASDAQ system links securities dealers who make markets in particular OTC securities and may maintain a position in the security. The dealers post on the NASDAQ system the highest price at which they will buy a security and the lowest price at which they will sell a security. They then act as intermediaries between buyers and sellers wishing to conduct transactions in the particular securities for which they have made a market. Trading on this network is regulated by the National Association of Securities Dealers (“NASD”).

Alternately, both listed and OTC securities may be traded through intermediaries who form a “fourth” market. Fourth-market intermediaries typically do not maintain security positions in the securities they are intermediating. Instead, they act only as agents for market participants, whether as buyers or sellers, maintaining the participant's anonymity and representing the participant's interests.

Originally the fourth market was largely a network of securities brokers communicating primarily by telephone (the “Rolodex” market). Later, Instinet (operated by Reuters, New York, N.Y.) began offering partially automated intermediary services by providing a computer network through which participants could post their security trading interests and subsequently could negotiate trades using standardized messages made available by the network. More recently, POSIT (operated by ITG, New York, N.Y.) and the Arizona Stock Exchange (“AZX”) (Phoenix, Ariz., URL “www.azx.com”) began providing more fully automated fourth-market intermediary services. Instinet, POSIT, and AZX thus all provide varying degrees of computerized intermediary services.

A security enters the marketplace when the issuer issues the security. Issued securities may be to a select group of known individuals, to qualified or accredited private investors, or to the public at large. For example, a corporation may issue shares of stock and sell the shares at an initial public offering. Alternatively, the corporation may issue shares of stock or grant a warrant for a particular number of shares in connection with consummation of an acquisition of another company. Securities may be issued in many ways and under numerous circumstances in addition to these few examples. The term “issue” is not limited to these examples, but rather includes any manner in which a security is initially provided by the issuing entity.

In the current investment system, the issuer obtains value for the security only in connection with its issuance. Thereafter, however, the security may be traded, may increase in value, may decrease in value, and may be the basis for any number of additional transactions. While these occurrences affect and may result in substantial benefit to the parties holding the securities and/or taking part in the transactions, the entity issuing the security does not derive any direct compensation for subsequent transactions involving its securities. Rather, the parties to the transaction retain all of the profit attendant to the transaction, despite the fact that the increase in value of the security, if any, is typically due, at least in part, to the hard work and success of the entity. Additionally, the intermediaries involved in the transaction typically benefit from the transaction, regardless of whether the participants in the transaction actually profited, by charging a commission for their services as intermediaries.

Because the issuing entity does not directly benefit financially from all increase in price of the security or by having a liquid market for its securities, the motivation for the entity to maximize security value is indirect. Typically recognized indirect incentives include enabling the company to issue additional securities at a higher price, for example in connection with an acquisition, due to the higher market value for the securities, a desire by security owners working for the entity to maximize the security's value so as to maximize the proceeds to themselves and other security owner on any sale of the entity, and the fact that certain security owners, such as shareholders, may have a right of action against the entity if the entity fails to act prudently and in the best interests of the security owners to make efforts to increase the value of the security.

### SUMMARY OF THE INVENTION

Accordingly, a need exists for a way to compensate the issuing entity when securities in the entity are involved in a transaction. According to one embodiment, the issuing entity collects a royalty whenever a security issued by that entity is traded.

According to another embodiment, a method of transferring a security in an entity includes consummating by a first party and a second party a transaction in the security, the first party and the second party being distinct from the entity, and paying a royalty on the transaction to the entity. In this method, the royalty may be paid by either the first party or the second party.

According to another embodiment, a method of transferring a security in an entity includes consummating a transaction between a first party that sells the security at a first price and a second party that buys the security at a second price different than the first price, and transferring at least a portion of a difference between the second price and first price to the entity. In this embodiment, the issuing entity does not participate, for example as an intermediary, in the step of consummating the transaction.

According to another embodiment, a method of conducting a transaction in a security issued by an entity includes consummating a transaction in the security from a first party to a second party, the first party and the second party being different parties, the first party and the second party being different than the entity, and providing a royalty to the entity as a result of the transaction. In this embodiment, the issuing entity does not participate in consummating the transaction.

According to another embodiment, a method of facilitating the purchase of a security issued by an entity includes facilitating payment of a first sum by a first party to a second party in connection with a transaction in the security, and facilitating payment of a second sum by at least one of the first party and the second party to the entity for the transaction in the security. In this embodiment, the entity does not facilitate payment of the second sum.

According to another embodiment, a method of transferring by a party having a first client a security issued by an entity includes obtaining by the party from the first client an instruction requesting the party to purchase the security or sell the security, executing the instruction on behalf of the party, and paying by the party to the entity a royalty upon execution of the instruction. In this embodiment, the party is not the issuing entity.

According to another embodiment, a method of transferring a security of an issuing entity owned by a mutual fund includes purchasing, by the mutual fund, the security, proportioning the mutual fund to determine a value of the mutual fund represented by the security, purchasing, by a first participant, a share of the mutual fund, and transferring, to the entity, a sum at least partially determined by the step of proportioning the mutual fund.

According to another embodiment, a method of structuring a sale in a security issued by an entity includes selling the security by a first party to a second party, the first and second parties being distinct entities from the issuing entity, and paying a royalty on the sale of the security to the entity that issued the security.

According to another embodiment, a computer-implemented method of exchanging securities issued by an entity includes receiving a first instruction to purchase at least one of the securities, receiving a second instruction to sell at least one of the securities, matching the first instruction with the second instruction to execute a transaction in the securities, and calculating a royalty to be paid to the entity for the transaction. Optionally, this method may also include determining if the transaction is a royalty generating transaction prior to calculating the royalty to be paid to the entity, automatically paying the royalty to the entity, debiting an account on behalf of the entity to collect the royalty, or transferring the royalty to an account maintained on behalf of the entity.

According to another embodiment, a computerized exchange for exchanging securities has at least one central processing unit (CPU), and at least one memory storage device having stored therein a set of exchange instructions for execution by the CPU. In this embodiment, the set of exchange instructions providing, when so executed, at least one user with the ability to conduct a transaction, and includes a first set of instructions constructed and arranged to consummate a transaction in securities issued by an issuing entity, and a second set of instructions constructed and arranged to calculate a royalty owed to the issuing entity due to the transaction.

According to another embodiment, a storage media containing software that, when executed on a computing system, performs a method for exchanging securities, the method includes the steps of consummating a transaction in securities issued by an issuing entity between a first party and a second party, the first and second party being distinct from the issuing entity, and determining a royalty to be paid to the issuing entity because of the transaction.

According to another embodiment, a royalty calculated by the steps of ascertaining an occurrence of a transaction in securities issued by an issuing entity between participants distinct from the entity, and determining the royalty to be paid to the issuing entity as a result of the occurrence of the transaction.

According to another embodiment, a computer system for use in the process of exchanging securities includes a computer having at least one central processing unit, an operating system, and at least one memory storage device having stored therein a set of exchange instructions for execution by the at least one CPU. In this embodiment, the set of exchange instructions provides, when so executed, at least one user with the ability to conduct a transaction. The set of exchange instructions includes a set of instructions constructed and arranged to receive inputs from participants related to transactions involving securities, a set of instructions constructed and arranged to facilitate the transactions, and a set of instructions constructed and arranged to calculate royalties owed to issuing entities of the securities involved in the transactions.

In this computer system, the set of exchange instructions may be configured to run autonomously on the computer to enable transactions to occur without the intervention of a human operator, or may be configured to require intervention or approval by a human operator for at least a portion of the transactions handled by the exchange. The set of exchange instructions may be configured to enable transactions to occur between anonymous parties. Additionally, the set of exchange instructions may be configured to determine a credit rating or a financial rating of one or more parties to the transaction.

The computer system may also include a communications unit configured and arranged to connect the computer to a wide area network or to a plurality of user terminals over a wide area network. The wide area network in this instance may include plurality of dedicated connections between the user terminals and the computer, or may include a public network such as the Internet. Communications may be encrypted using an encryption algorithm.

The set of exchange instructions may be configured to match buy and sell orders and to calculate the royalty to be paid to the issuing entity upon completion of the transaction or upon matching of a buy and sell order. The set of exchange instructions may be configured to facilitate transactions 24 hours per day, seven days per week or for more limited defined trading hours.

According to another embodiment, an exchange is configured to intermediate transactions in securities issued by at least one entity, and includes a first set of rules relating to a protocol for conducting transactions between participants in the securities, and a second set of rules relating to payment of royalties to issuing entities of securities involved in transactions. The exchange may also include a third set of rules relating to payment of an exchange fee to the exchange for transactions conducted on the exchange, and at least one computer programmed to implement at least one of the first set of rules and the second set of rules.

According to another embodiment, a computerized stock exchange includes a computer programmed to implement a first set of stock exchange rules relating to a protocol for conducting transactions between participants in stock on the exchange, and a computer programmed to implement a second set of stock exchange rules relating to payment of royalties to entities that issued the stocks involved in the transactions on the exchange.

According to another embodiment, a set of rules governing transactions on an exchange includes rules relating to protocol for conducting transactions in securities between participants and rules relating to payment of royalties to entities that issued the securities involved in the transactions.

In one or more of these embodiments, the security may take the form of a voting right in the entity, a debt interest in the entity, such as a note, bond, or debenture, an equity interest in the entity, such as stock issued by the entity, or any other security as that term is defined herein. The security may be issued by a corporation, a partnership, a limited liability company, a limited liability partnership, a trust, a labor group, a union, a mutual fund, or any other entity as that term is defined herein.

The royalty may take the form of a percentage of the seller's profit, a percentage of an increase in value of the security from a previous transaction involving the same security, a percentage of the value of the securities involved in the transaction, a percentage of the number of securities involved in the transaction, a portion of the security itself, a right to buy other securities, a fee, a commission, a portion of a spread between any two of the sales price, ask price and bid price, a portion of a fee due to an exchange on which the transaction took place, a portion of a fee due to any intermediary, or any other quantum of value. Calculation of the royalty is not limited to the variables above, rather, the royalty can be derived from any one or a combination of any of these variables, or any other reasonable algorithm which can, but need not, take into account these variables.

The royalty may be due to the entity for every transaction, for every predetermined number of transactions, for a sets of transactions, for randomly selected transactions, for transactions involving only particular securities issued by that entity, only for particular types of transactions, or for any other subset of transactions.

Transactions supporting payment of a royalty may involve a transfer of all ownership rights in the security, a transfer of partial ownership rights in the security, a transfer of voting rights associated with the security, a transaction in an options in the security, such as a purchase of the option, or a closing transaction in the option. In connection with options transactions, the transaction may be deemed to have occurred when the option expires, or when the option is exercised.

The entity may be a member of a pool of entities—a set of strategic alliances between entities, a market sector, etc. The royalty may be transferred to the pool and subsequently distributed according to a policy of the pool of entities.

### BRIEF DESCRIPTION OF THE DRAWINGS

This invention is pointed out with particularity in the appended claims. The above and further advantages of this invention may be better understood by referring to the following description when taken in conjunction with the accompanying drawings. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a functional block diagram of an illustrative method of providing all economic benefit to an issuing entity when its securities are involved in a transaction;

FIG. 2 is a functional block diagram of an illustrative computerized exchange for use in connection with one embodiment of this invention;

FIG. 3 is a functional block diagram of the computerized exchange of FIG. 2 connected to a plurality of trading computers via a wide area network;

FIG. 4 is a diagram of the flow of one embodiment of a software program to be executed by the computerized exchange of FIG. 2 in connection with a simple transaction involving buy and sell orders of securities;

FIG. 5 is a functional block diagram of an illustrative algorithm for use by the computerized exchange of FIG. 2 during a royalty calculation;

FIG. 6 is a functional block diagram of an illustrative method of conducting a transaction directly between parties and providing an economic benefit to the entity that issued the security involved in the transaction;

FIG. 7 is a functional block diagram of an illustrative method of conducting a transaction between parties with intermediaries and providing an economic benefit to the entity that issued the security involved in the transaction;

FIG. 8 is a functional block diagram of an illustrative method of conducting a transaction involving shares of a closed end mutual fund and providing an economic benefit to the entities that issued the securities owned by the mutual fund;

FIG. 9 is a functional block diagram of an illustrative method of conducting a transaction involving shares of a open ended mutual fund and providing an economic benefit to the entities that issued the securities owned by the mutual fund; and

FIG. 10 is a functional block diagram of an illustrative method of conducting a transaction involving options in securities of an entity and providing an economic benefit to the entity that issued the securities on which the option is based.

### DETAILED DESCRIPTION

This invention, in one aspect, relates to a method of conducting transactions in securities that will provide an economic benefit to the issuing entity whenever a security issued by the entity is involved in a transaction. According to one illustrative embodiment of the present invention, for all or a selected subset of transactions, an economic benefit is transferred to the entity issuing the security involved in the transaction. The economic benefit may be in the form of a royalty or commission, or percentage of the seller's profit, or any other quantum of value, as discussed in greater detail below.

Another aspect of this invention relates to an exchange having rules of operation designed to provide an economic benefit to the issuing entity whenever a security issued by the entity is involved in a transaction. The exchange may take the form of a traditional exchange, such as the NYSE, or may involve a computerized exchange, such as the exchange disclosed in U.S. Pat. No. 5,873,071, entitled COMPUTER METHOD AND SYSTEM FOR INTERMEDIATED EXCHANGE OF COMMODITIES, assigned to ITG, Inc., the content of which is hereby incorporated by reference. The invention is not limited to implementation according to these exemplary exchanges, but rather includes any exchange having rules of operation designed to provide an economic benefit to the issuing entity, as discussed in greater detail below

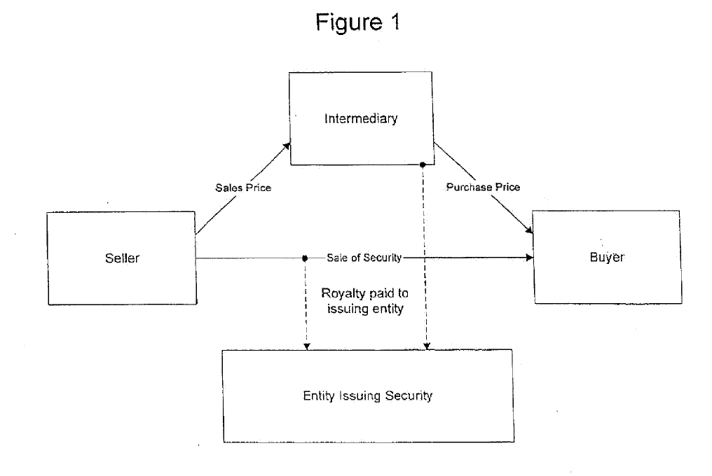

As shown in FIG. 1, a transaction in a security may be direct or may be intermediated. For example, in a direct transaction, a security is sold by a seller to a buyer. In an intermediated transaction the security is sold from a seller to a buyer with the assistance of one or more intermediaries. In either instance, according to this invention, a royalty is paid to the entity issuing the security as a result of the transaction involving the security.

The royalty in this instance may take the form of any measure of economic benefit to the issuing entity or of economic detriment to one of the other parties or intermediaries involved in the transaction. For example, the value may include a percentage of the seller's profit, a percentage of the value of the securities involved in the transaction, a percentage of a tracking index (e.g. ask or bid price), a percentage of the number of securities involved in the transaction, a portion of the security itself, a right to buy other securities, a straight fee, a commission, a portion of a spread between any two of the sales price, ask price and bid price, a portion of a fee due to the exchange on which the transaction took place, a portion of a fee due to any intermediary, or any other measure of value. Calculation of the royalty is not limited to the variables above, rather, the royalty can be derived from any one or a combination of any of these variables, or any other reasonable algorithm which can, but need not, take into account these variables.

As used herein, the terms “economic benefit” and “royalty” may be used interchangeably to refer to the value that is to be transferred to the entity in connection with transactions subsequent to the issuance of a security, however computed.

Royalties may be paid to the issuing entity. Royalties may be due to the entity for every transaction, for every predetermined number of transactions, for various sets or subsets of transactions, for randomly selected transactions, for transactions involving only particular securities or for any other subset of transactions. The transfer of economic benefit to the entity may occur only in connection with particular types of transactions, such as the transfer of all ownership rights in a security, when the transfer of partial ownership rights in the security when voting rights are transferred, or when options in the security are purchased, sold, exercised, or expire. Many other types of transactions may constitute royalty generating transactions, and the invention is not limited to only calculating a royalty in connection with a particular type of transaction or group of transactions.

A computer system forming a computerized exchange may be provided to enable transactions in securities and to calculate royalties payable to the issuing entity for transactions involving securities issued by that entity. In one embodiment, an exchange is formed as a computer program running on a computer or group of computers configured to receive input from participants wishing to conduct transactions in securities and to enable securities to be exchanged. The computer, in this instance, may be configured to run autonomously to enable transactions to occur (without the intervention of a human operator), or may require intervention or approval for all, a selected subset, or particular classes of transactions. The invention is not limited to the disclosed embodiments, and may take on many different forms depending on the particular requirements of the exchange, the rules of the exchange, and the type of computer equipment employed.

A computerized exchange, may optionally, but need not necessarily, perform additional intermediary functions, including enabling transactions to occur between anonymous parties, determining credit or financial abilities of the parties to the transaction, and any other functions commonly performed by one or more intermediaries, clearing agencies, transfer agents, or exchange members.

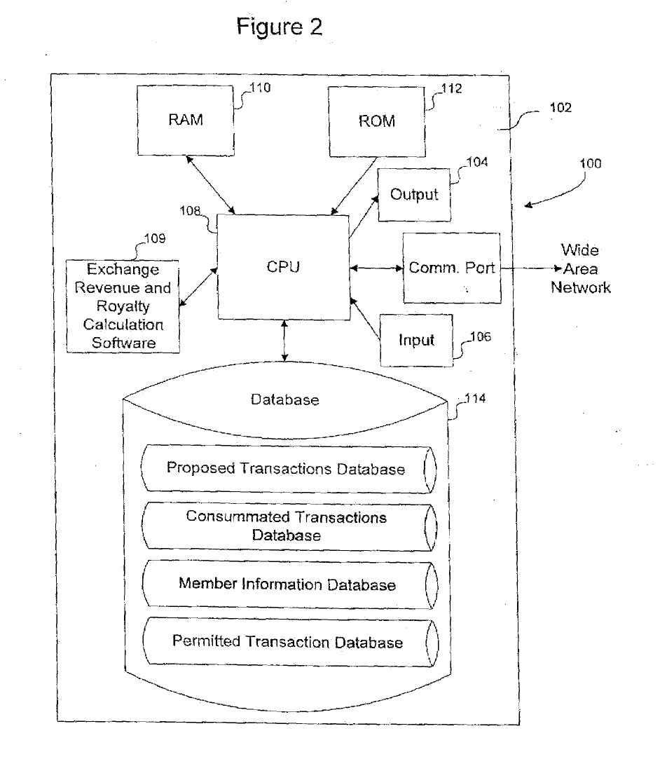

In the embodiment shown in FIG. 2, a computer system 100 for implementing the method of exchanging securities of FIG. 1 includes at least one main unit 102 connected to a wide area network. The main unit 102 may include a processor (CPU 108) running exchange revenue and royalty calculation software 109, connected to a memory system including various memory devices, such as random access memory RAM 110, read only memory ROM 112, and one or more databases 114.

The computer system may be a general purpose computer system which is programmable using a computer programming language, such as C, C++, Java, or other language, such as a scripting language or even assembly language. The computer system may also be specially programmed, special purpose hardware, or an application specific integrated circuit (ASIC).

In a general purpose computer system, the processor is typically a commercially available microprocessor, such as Pentium series processor available from Intel, or other similar commercially available device. Such a microprocessor executes a program called an operating system, such as UNIX, Linux, Windows NT, Windows 95, 98, or 2000, or any other commercially available operating system, which controls the execution of other computer programs and provides scheduling, debugging, input/output control, accounting, compilation, storage assignment, data management, memory management, communication control and related services, and many other functions. The processor and operating system defines a computer platform for which application programs in high-level programming languages are written.

The database 114 may be any kind of database, including a relational database, object-oriented database, unstructured database, or other database. Example relational databases include Oracle 8I from Oracle Corporation of Redwood City, Calif.; Informix Dynamic Server from Informix Software, inc. of Menlo Park, Calif.; DB2 from International Business Machines of Yorktown Heights, N.Y.; and Access from Microsoft Corporation of Redmond, Wash. An example object-oriented database is ObjectStore from Object Design of Burlington, Mass. An example unstructured database is Notes from the Lotus Corporation, of Cambridge, Mass. A database also may be constructed using a flat file system, for example by using files with character-delimited fields, such as in early versions of dBASE, now known as Visual dBASE from Inprise Corp. of Scotts Valley, Calif., formerly Borland International Corp.

The main unit 102 may optionally include or be connected to an output device 104 configured to provide information to a user. Example output devices include cathode ray tube (CRT) displays, liquid crystal displays (LCD) and other video output devices, printers, communication devices such as modems, storage devices such as a disk or tape, and audio or video output devices. Likewise, one or more input devices 106 may be included with or connected to the main unit 102 and configured to enable a user to input information to the main unit 102. Example input devices include a keyboard, keypad, track ball, mouse, pen and tablet, communication device, and data input devices such as audio and video capture devices. It should be understood that the invention is not limited to the particular input or output devices used in combination with the computer system or to those described herein.

It also should be understood that the invention is not limited to a particular computer platform, particular processor, or particular high-level programming language. Additionally, the computer system may be multiprocessor computer system or may include multiple computers connected over a computer network. It further should be understood that each module or step shown in the accompanying figures and the substeps or subparts shown in the remaining figures may correspond to separate modules of a computer program, or may be separate computer programs. Such modules may be operable on separate computers. The data produced by these components may be stored in a memory system or transmitted between computer systems.

Such a system may be implemented in software, hardware, or firmware, or any combination thereof. The various elements of the method of exchanging securities disclosed herein, either individually or in combination, may be implemented as a computer program product, such as Exchange Revenue and Royalty Calculation Software 109, tangibly embodied in a machine-readable storage device for execution by the computer processor 108. Various steps of the process may be performed by the computer processor 108 executing the program 109 tangibly embodied on a computer-readable medium to perform functions by operating on input and generating output. Computer programming languages suitable for implementing such a system include procedural programming languages, object-oriented programming languages, and combinations of the two.

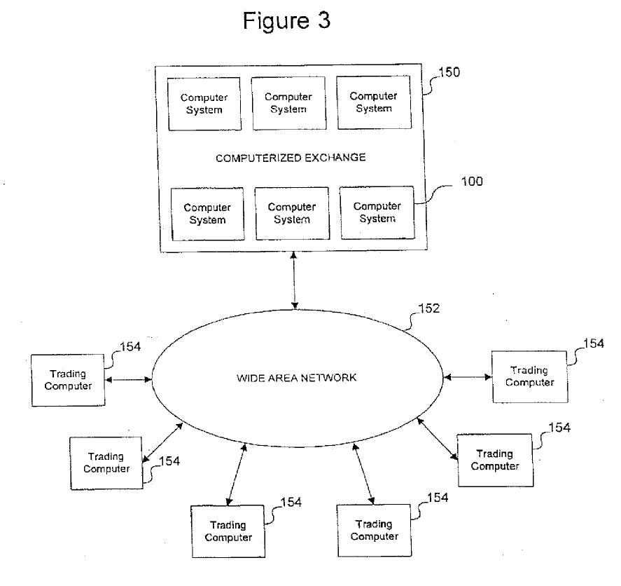

In one embodiment, as shown in FIG. 3, one or more computer systems 100 form a computerized exchange 150 connected to a plurality of user terminals 154 via a wide area network 152. The wide area network 152 may be formed from a plurality of dedicated connections between the user terminals 154 and the computerized exchange 150, or may take place, in whole or in part, over a public network such as the Internet. Communication between the user terminals 154 and the computerized exchange 150 may take place according to any protocol, such as TCP/IP, and may include any desired level of interaction between the user terminals 154 and the computerized exchange 150. To enhance security, especially where communication takes place over a publicly accessible network such as the Internet, communications facilitating or relating to transactions may be encrypted using an encryption algorithm.

One example of a computerized exchange system, including a description of messages to be sent between a user terminal and a computerized exchange computer, is set forth in U.S. Pat. No. 5,873,071, the content of which is hereby incorporated by reference. The invention is not limited, however, to the particular computerized exchange described in this patent or to the particular message protocol or communication protocol used therein. Rather, the invention applies broadly to any computerized or traditional exchange that may be configured to implement the algorithms and methods of the invention.

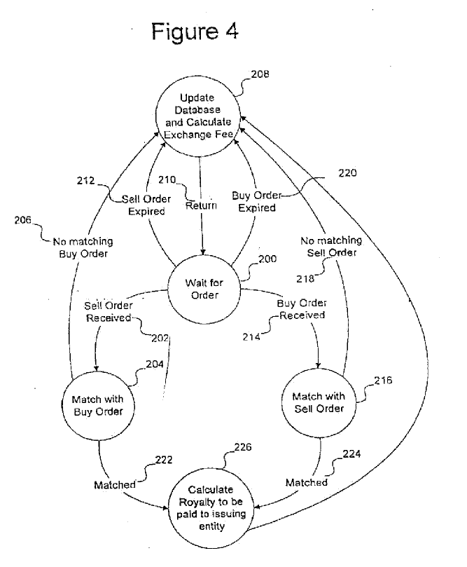

As shown in FIG. 2, the exchange revenue and royalty calculation software 109 contains algorithms for execution by the CPU 108 that enables the CPU 108 to perform the methods set forth herein. One such exemplary algorithm for execution by the CPU 108 is set forth in FIG. 4.

This algorithm set forth in FIG. 4 may be used to implement, in one exemplary embodiment, a computerized exchange specifically configured to intermediate transactions in a particular type of security, such as stocks, between participants. The computerized exchange in this embodiment may also intermediate transactions in its own securities, such as stock it has issued. Optionally, in this instance, the exchange may elect to forego collection of a royalty on transactions in its own stock, since the exchange is already collecting an exchange fee for its role in the transaction. Alternatively, the algorithm may be used to implement other embodiments configured to intermediate transactions in other types of securities.

As shown in FIG. 4, the exchange software is configured to match buy and sell orders and to calculate the royalty to be paid to the issuing entity upon completion of a transaction or upon matching of a buy and sell order.

Specifically, the exchange will wait for an order, step 200, until either a buy or sell order is received. The exchange may be configured to be open to conduct transactions 24 hours per day, seven days per week, or for a more limited period of time, such as if the exchange were to keep limited defined trading hours. Likewise, the exchange may be configured to restrict the period of time during which particular securities may be traded, such as to conduct an on-line auction for a particular security or class of securities.

The computerized exchange may be configured to send messages updating participants in transactions at predefined intervals, or upon the occurrence of particular events, such as upon completion of a transaction or at multiple stages during the transaction. The invention is not limited to any particular implementation of a system for notifying participants engaged in transactions.

If a sell order is received, step 202, the exchange attempts to match the sell order with a corresponding buy order, step 204. If there is no matching buy order, step 206, the computerized exchange updates the database, step 208, so that the sell order may be matched with future buy orders, and then returns, step 210, to wait for another order, step 200. If the sell order expires, step 212, before it can be matched with a buy order, the computerized exchange updates the database, step 208, and returns, step 210, to wait for subsequent orders. Each time the database is updated, step 208, or at any other point in this algorithm, the Exchange may calculate a fee to be paid to the Exchange for its roll in the transaction. The Exchange may, as a matter of policy, determine that a fee should be charged at only particular stages during the transaction such as when a transaction is consummated, when a buy or sell order is received, or at any other stage. For convenience, the art of calculating the exchange fee has been included with the act of updating the database, since the database is updated frequently during the algorithm. The invention is not limited in this respect, however.

A similar process occurs when a buy order is received. Specifically, if a buy order is received, step 214, the computerized exchange attempts to match the buy order with a corresponding sell order, step 216. To do this, the computerized exchange will typically poll the database to see if there is any corresponding sell order with parameters indicative of the ability for the respective parties to successfully complete a transaction. The specific criteria used to match buy and sell orders will depend on any number of a variety of factors, such as the type of security involved, the specific rules of the exchange governing the manner in which transactions may proceed, and the protocol used by the exchange in trading securities. The invention is not limited to the criteria or protocol used to match buy and sell orders.

If the computerized exchange is not able to match the buy order with a sell order, step 218, the exchange updates the database, step 208, and returns, step 210, to wait for another order, step 200. Updating the database in this manner enables the computerized exchange to match the buy order with subsequently received sell orders. If the buy order expires, step 220, the computerized exchange updates the database, step 208, and returns to wait for subsequent orders.

The computerized exchange may be configured to process numerous types of orders, such as simple buy or sell orders, as illustrated, or more complicated orders. Examples of more complicated orders include orders with a time duration, orders that are contingent upon the occurrence of another event, etc. Many types of orders are presently used in existing exchanges and the invention is not limited to any particular type of order, any particular protocol used by the exchange to process the order, or to any particular method used by the exchange to execute transactions or match various types of orders.

If the computerized exchange matches a sell order with a buy order, step 222, or matches a buy order with a sell order, step 224, the computerized exchange calculates a royalty to be paid to the issuing entity of the security involved in the transaction, step 226. Thereafter, the database is updated, step 208, to reflect that a transaction has been completed and, optionally, that the buy and sell orders have been filled and the exchange fee is calculated. The computerized exchange then returns, step 210, to wait for another order, step 200.

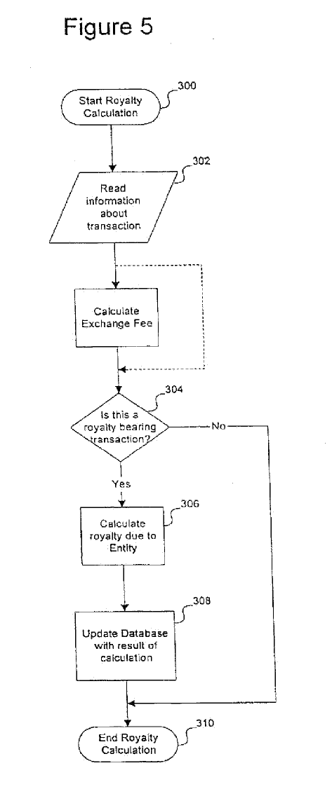

One embodiment of an algorithm for use by the computerized exchange when calculating the royalty owed to the issuing entity is set forth in FIG. 5. As shown in FIG. 5, the computerized exchange starts the royalty calculation, step 300, and reads information about the consummated transaction, step 302, The exchange may then optionally calculate the exchange fee, step 303. Calculation of the exchange fee may take place at any point in this algorithm, or may take place in a separate algorithm. The exchange then determines if this type of transaction is a royalty generating transaction 304, and hence determines if it is necessary to pay a royalty to the issuing entity. If the transaction is not a royalty generating transaction, the computerized exchange ends the royalty calculation algorithm, step 310, or determines that the royalty to be paid is $0.00,

The computerized exchange may take many factors into account when determining whether the transaction qualifies as a royalty generating transaction. For example, the issuing entity of the particular security involved in the transaction may have elected not to receive royalties when its securities are exchanged, or may have elected not to receive royalties for selected transactions, transactions involving a particular participant, or transactions involving a particular type of security. Accordingly, in that instance, the computerized exchange would know that it was not to calculate a royalty for transactions involving those entities securities. Likewise, the computerized exchange may determine that a particular transaction is not a royalty generating transaction if the transaction is smaller than a threshold size. This may be advantageous, for example, where the costs of assessing or collecting a royalty exceed the value of the royalty. Many other factors may also cause the transaction to qualify as a non-royalty generating transaction. For example, royalties may be calculated only on a portion of the total number of transactions, only on particular types of transactions, such as stock transactions and not option transactions, or for transactions with particular participants. Indeed, the computerized exchange can be programmed to exempt any particular transaction or class of transactions based on any factor or combination of factors identified by the issuing entity, the exchange itself or its rules, intermediaries, or by a governmental regulatory agency.

If the transaction is a royalty generating transaction, the computerized exchange proceeds to calculate the royalty, step 306 and update the database with the result of the calculation, step 308. The computerized exchange then ends the royalty calculation, step 310. As discussed below, the computerized exchange can calculate the royalty owed on the transaction in any manner, including but not limited to a percentage of the fees received by the exchange, as a portion of a brokers fee received for the transaction, as a portion of the increase in value of the security since it last was purchased or sold, or any other factor that could advantageously be used in calculating the amount adequate to compensate the issuing entity for the transaction.

Optionally, the computerized exchange may automatically debit or credit accounts of participants in the transaction, and may transfer the royalty to an account maintained on behalf of the entity. By authorizing the computerized exchange to transfer funds between accounts, in addition to calculation of the royalty, payment of the royalty to the entity is automatically accomplished without necessitating the intervention of additional third parties. The invention is not limited in this regard, however, as any method of collecting the royalty is encompassed thereby.

Although the computerized exchange has been described in connection with the transaction disclosed in FIG. 1, the computerized exchange may also be adapted for use in facilitating numerous other transactions, and the invention is not limited to a computerized exchange configured to facilitate any one particular transaction. Several other transactions that may be facilitated by the computerized exchange are discussed below. These transactions likewise are not exhaustive, and the invention is not limited to the particular transactions described herein but extends to any transaction that results in economic benefit to the issuing entity.

The following transactions can be implemented using any of the computer systems, networks, hardware, software, and/or algorithms described herein, e.g. with reference to FIGS. 2-4.

Direct Transactions

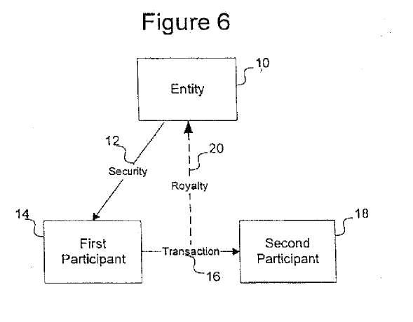

A diagrammatical representation of one illustrative method of compensating the entity for transactions involving securities issued by the entity is set forth in FIG. 6. As shown in FIG. 6, the entity 10 issues a security 12 in a first offering to a first participant 14. The first participant 14 subsequently conducts a transaction 16 involving the security issued by the entity with a second participant 18. A byproduct of that transaction is to transfer a royalty 20 to the entity. Although the illustrated transaction resulting in generation of a royalty in this scenario is the second transaction (the first transaction occurs when the security is first offered to the first participant) the invention is not limited in this respect, and subsequent transactions likewise may be royalty generating transactions. Stated differently, royalty bearing transactions may occur for every transaction n where n>1.

Collection of the royalty by the entity may be accomplished in any number of ways. When stock is issued, for example, the corporation issuing the stock is required to maintain a shareholder list. The corporation may charge a fee to update the stockholder list to list the new owner of the stock. Another way of collecting the royalty would be to contractually obligate, in the bylaws or articles of incorporation, that the purchasing or selling party to the transaction must pay the company a royally in connection with the transaction. It may be advisable for the issuing entity to maintain contractual privity with subsequent holders who take securities in transactions.

Intermediated Transactions

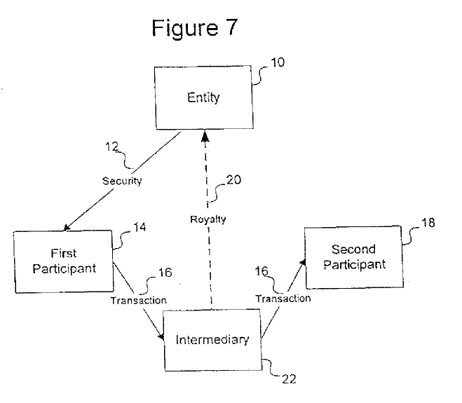

FIG. 7 illustrates a transaction between two participants and at least one intermediary. As shown in FIG. 7, the entity 10 issues a security 12 during a first offering to the first participant 14. As in FIG. 6, the first participant 14 subsequently conducts a transaction 16 involving the security 12 issued by the entity 10 with a second participant 18. In this instance, however, one or more intermediaries 22 facilitate the transaction 16. The intermediary's role may be passive, such as by providing a forum in which transactions may take place, or may be active, such that the intermediary participates in the transaction. For example, the intermediary may be an active intermediary by collecting a sell offer from the first participant 14 and a buy bid from the second participant 18, and matching the offer and bid to enable the participants to consummate the transaction at a mutually agreeable price. The invention is not limited to a particular intermediary, active or passive intermediary, or to any particular protocol used by the intermediary to intermediate transactions. Thus, many more complicated scenarios may be encountered by participants and intermediaries, and the invention is not limited to any one particular type of intermediary or the form of transaction brokered by the intermediaries. The invention is likewise not limited to a single intermediary, as, multiple intermediaries may be involved in a particular transaction.

The consummation of the transaction results in a transfer of a royalty 20 to the entity 10. As in FIG. 6, the royalty may be paid by the first participant 14 or the second participant 18 and may be collected using any available method. In this instances however, the presence of the intermediary 22 may make it more convenient to collect the royalty from the intermediary 22. For example, the intermediary 22 typically will charge for its services associated with facilitating or brokering the transaction 16. Collection from the intermediary 22 in this instance, who is otherwise profiting from the transaction 16, would be straightforward and may be accomplished contractually. For example, an exchange may collect a fee based on a percentage of the value of the transaction 16, a flat fee for its role in facilitating and/or intermediating the transaction 16, or a fee based on the spread between buy and sell prices of the security 12 trading on the exchange. The rules of the exchange, in this embodiment, may obligate the exchange to determine the royalty owed the issuing entity 10, optionally as a percentage or portion of the fee collected by the exchange itself. The rules of the exchange may additionally impose other obligations on the exchange, such as an obligation to pay the determined royalty 20 to the entity 10 or to collect the determined royalty 20 on behalf of the entity 10. Where more than one intermediary is involved in a particular transaction, one or more royalties may be collected from one, a subset, or all of the intermediaries. As with direct transactions royalties may be due for every transaction N where N>1.

Options Transactions

An option is the right either to buy or sell a specified amount or value of a particular underlying interest or security at a fixed exercise price. Most options have an expiration date after which the holders right to exercise the option ceases. An option that gives the holder a right to buy the underlying securities is a call option, and an option which confers a right to sell the underlying securities is called a put option. A person that sells an option is called the option writer, and a person that buys an option is called an option holder.

In the United States, options are backed by the Options Clearing Corporation (“OCC”), which also creates a system for exchanging options through creation of a series of rules governing options transactions. The OCC is designed such that the performance of all options is between the OCC and a group of firms called clearing members that carry the positions of all option holders and option writers in their accounts at the OCC. Under this system, a particular option holder will look to the system created by the OCC's rules, rather than to any particular option writer, for performance of the options. Similarly, option writers must perform their obligations under the OCC system and are not obligated to any particular option holder. The invention is not limited to transactions in options occurring in accordance with the OCC's rules.

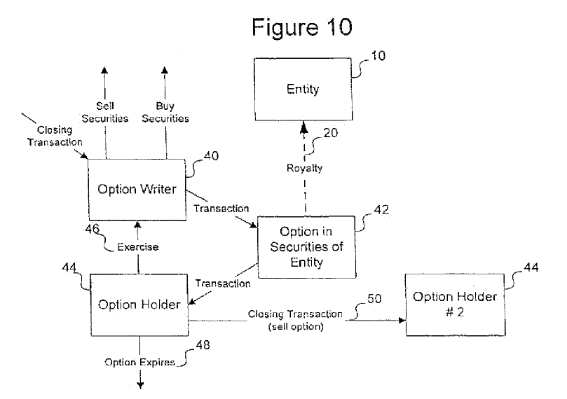

FIG. 10 illustrates several transactions that can take place in connection in a typical options context, The hierarchy imposed by the OCC system on these transactions has not been illustrated to avoid obfuscation.

As shown in FIG. 10, an entity issues securities. Subsequently, an option writer 40 may write an option 42 in securities of the entity. An option holder 44 may then purchase the option 42. Both the act of writing and purchasing the option 42 may be royalty generating transactions for the issuing entity 10. Also, as discussed above, under the OCC's rules, the option writer 40 does not necessarily write the option 42 to the option holder 44. Rather, the act of writing the option 42 and the act of purchasing the option 40 are distinct transactions that take place independent 14 of each other.

Subsequently, the option holder 44 may exercise the option 46, may hold the option 42 until it expires 48, or may engage in a closing transaction 50 whereby the option holder 44 cancels out his position in the option 42. A closing transaction 50 by an option holder 44 is an offsetting writing of an identical option 42. Likewise, a closing transaction 50 by an option writer 40 is an offsetting purchase of an identical option 42. Off market transactions, such as gifts of options 42 or sales of options 42, may also occur.

If the option holder 44 decides to exercise the option, step 46, the option holder 44 is either entitled to purchase/sell the specified number of securities at the exercise price, if the option 42 is a physical delivery option; or the option holder 44 is entitled to a specified amount of money, if the option 42 is a cash-settled option.

All of these transactions involving options 42 are fundamentally based on the underlying security. Accordingly, a royalty 20 may be payable to the entity 10 as a result of one or more of these transactions associated with options. The specific transaction or combination of transactions that will result in a royalty 20 to the entity is subject to the specific terms of the option 42 involved. For example, the option 42 may be structured such that a percentage of the option contract price is paid to the entity 10 when the option 42 is first issued. Alternatively, the option 42 may be structured such that part of the exercise price is paid to the entity 10 in the form of a royalty 20. A third alternative may be that a royalty 20 on the option 42 may be payable anytime the option holder 44 or option writer 46 engages in a closing transaction 50, any time an option expires 42, or any time the option 42 is exercised. The entity 10 may also be entitled to a royalty 20 anytime an option writer 40 covers his position in the option 42, or when the option writer 40 is forced to purchase or sell securities according to the terms of the option 42. Any event or combination of events involving an option 42 may conceivably be used as a royalty-generating transaction resulting in payment of a royalty 20 to the entity 10. The computerized exchange, discussed above, may be configured to facilitate transactions in options 42 and to calculate royalties 20 for any one or more of these potential royalty generating events.

Mutual Fund Transactions

In an illustrative embodiment, the invention also applies to distribute economic benefit to issuing entities when shares of a fund, such as a mutual fund, that owns the securities are involved in a transaction. A “fund,” as that term is used herein, includes any holder of one or more securities who sells securities valued or based at least in part on the value of the held securities. The term fund therefore generally encompasses mutual funds, both open and closed-ended, hedge funds, and other securities generally marketed as deriving their value from a fund as that term is generally understood.

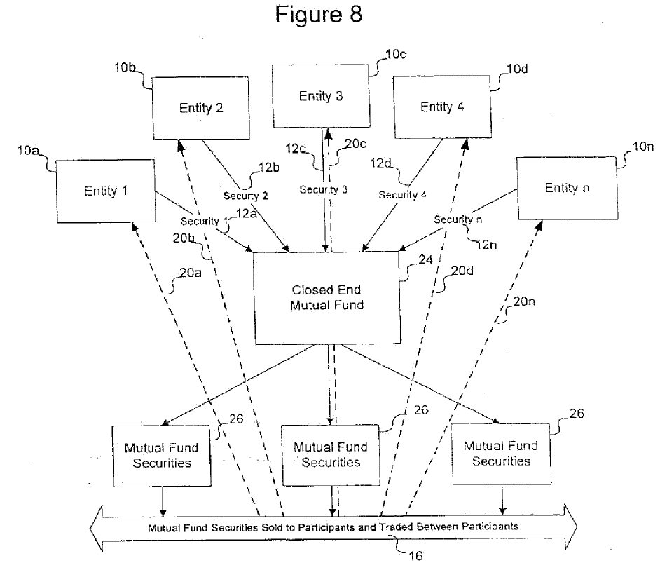

One example of how this may operate in connection with a closed-end mutual fund is illustrated in FIG. 8. For example, as shown in FIG. 8, a typical closed-end mutual fund 24 may own a large number of securities 12a-n issued by multiple entities 10a-n. These securities 12a-n may be acquired in initial offerings or from participants in transactions, such as those described above.

Mutual fund securities 26, typically representing a portion of the total mutual fund 24, are sold to the public at large or to a subsegment of the public in an initial offering. Since the mutual fund is closed-ended, meaning that only a limited number of mutual fund securities 26 are issued, a market for the mutual fund securities 26 may develop independent of the mutual fund 24. Thus, subsequent to the first offering, the mutual fund securities 26 may be involved in transactions just like any other security. However, a transaction involving a mutual fund security 26 may be considered a transaction in a portion of each security 12a-n owned by the mutual fund 24, since the mutual fund's primary assets are the securities 12a-n. Thus, a royalty 20a-n may be payable to the entities 10a-n for transactions involving the mutual fund securities 26. A royalty 20 may also be payable to the entities 101a-n when the mutual fund securities 26 are initially sold, i.e., on the first sale of the mutual fund securities. Likewise, transactions in mutual fund securities 26 may be royalty generating transactions for the mutual fund itself, thus entitling the mutual fund to collect a royalty from the participants and/or intermediaries involved in the mutual fund equity transactions. In this situation, the royalties due to the entities 1 Oa-n and the royalties due to the mutual fund 24 may be separately calculated and separately payable, or may be jointly calculated and paid to the mutual fund 24 for distribution to the entities 10a-n or to a third party for distribution to the entities 10a-n and the mutual fund 24. The invention is not limited to the particular method of calculating and distributing royalties. For simplicity and to avoid obfuscation, only royalties flowing to the entities 10a-n are illustrated in FIG. 8. The royalty is then at least partially distributed to the issuing entities having shares owned by the mutual fund.

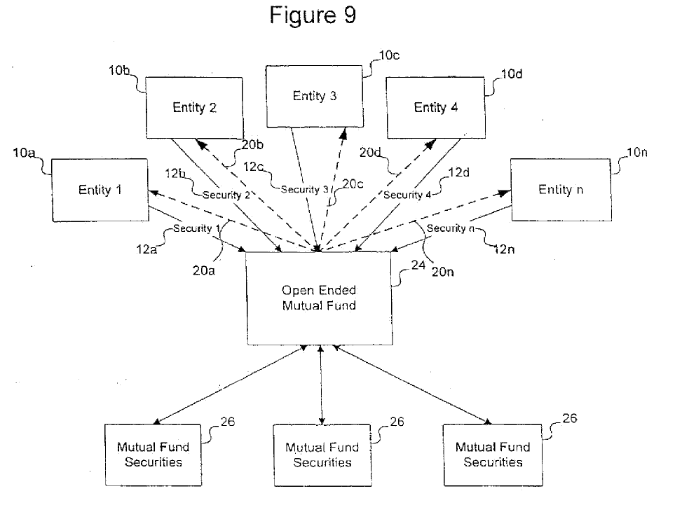

For open-end mutual funds, such as the mutual fund 24 illustrated in FIG. 9, the basic configuration is the same except that the mutual fund 24 is not limited in the number of mutual fund securities 26 it can sell. Accordingly, a secondary market for the mutual fund securities 26 typically will not develop. Instead, the mutual fund securities 26 are purchased from and 5 redeemed to the mutual fund 24 directly. The net asset value of the mutual fund 24 at the end of a calculation period, typically at the end of the day, divided by the number of outstanding mutual fund securities 26, indicates the per share price of each mutual fund security 26.

In this scenario, each time the mutual fund 24 sells a mutual fund security 26, the sale constitutes an initial offering. Accordingly, these sales would not result in generation of a royalty to the mutual fund 24. However, the sale of 10a-n mutual fund securities is a second or n^{th} transaction in the underlying securities 12a-n a transaction on which royalties are due to the issuing entities.

When a closed-end mutual fund 24 or an open-end mutual fund 24 sells a mutual fund security 26, the sale constitutes a transaction in the securities 12a-n, since the vast majority of the assets of the mutual fund 24 are formed from the securities 12a-n. Accordingly, the entity 10a-n issuing the security 12a-n will be entitled to receive a royalty for that sale. Likewise, when mutual fund securities 26 of a closed-ended mutual fund are traded in the secondary market, or in the relatively rare circumstance where mutual fund equities 26 of an open-ended mutual fund 24 are traded in the secondary market, the transactions involving those equities 26 comprise both 20 a transaction in the mutual fund securities 26, thus potentially entitling the mutual fund 24 to collect a royalty, as well as a transaction in the securities 12a-n forming the assets of the mutual fund 24. Thus, the entities 10a-n potentially will be entitled to receive a royalty on these sales as well.

There are many ways of computing the amount of royalty 20a-n that should be transferred to the entities 10a-n as a result of transactions involving the mutual fund securities 26 For example, the economic benefit to any particular entity 10a-n could be computed as a percentage of the total royalty to be paid. The percentage of the total royalty, in turn, may be based on any rational basis, such as the total value of the securities issued by the entity and owned by the fund divided by the total value of the fund, the total number of securities issued by the entity and owned by the fund divided by the total number of securities owned by the mutual fund, as a percentage of the total increase in value of the fund ascribable to the security as compared to the overall increase in value of the mutual fund, or in any other manner. As in direct or intermediated transactions between participants, the frequency with which the economic benefit is transferred to the entity may vary depending on these same factors.

The royalty to the entity may be taken as part of the load charged by the mutual fund, may be taken from fees collected by the mutual fund for administering the mutual fund, or may be taken from any other source of income to the mutual fund. Optionally, the royalty due to the entity may be taken as a portion of royalties payable to the mutual fund because of secondary transactions in issued mutual fund securities 26.

A computerized exchange, as discussed above, may be configured to implement transactions in mutual fund securities 26 and to calculate royalty payments 20a-n due to issuing entities 10a-n and the mutual funds 24 themselves when mutual fund securities 26 are involved in transactions.

Another variation on the standard transfer of securities giving rise to generation and transfer of economic benefit to the entity involves the situation where a single brokerage or investment group transfers ownership in the economic entity from one client to another client. In this situation, the transfer of ownership between clients may be treated as a transfer from buyer to seller, discussed above, even though record ownership with the company may not change.

Having thus described at least one illustrative embodiment of the invention, various alterations, modifications and improvements will readily occur to those skilled in the art. Such alterations, modifications, and improvements are intended to be within the spirit and scope of the invention. Accordingly, the foregoing description is by way of example only and is not intended as limiting.

What is claimed is:

1. A computer-implemented method of transferring a security in an entity, the method comprising operating a programmed processor to execute programmed instructions stored on a tangible, computer-readable medium, to:
consummate on a computerized exchange by a first party and a second party a transaction in the security, the first party and the second party being distinct from the entity; and
pay a royalty on the transaction to the entity,
wherein said security comprises one or more fungible shares representing an interest in the entity, and which shares are unrestricted as to alienation and traded on a securities exchange.

2. The method of claim 1, wherein the act of paying a royalty on the transaction is performed by at least one of the first party and the second party.

3-7. (canceled)

8. A computer-implemented method of structuring a sale in a security issued by an entity, comprising operating a programmed processor to execute programmed instructions stored on a tangible, computer-readable medium, to:
sell the security by a first party to a second party, the first and second parties being distinct entities from the issuing entity; and
pay a royalty on the sale of the security to the entity that issued the security,
wherein said security comprises one or more fungible shares representing an interest in the entity, and which shares are unrestricted as to alienation and traded on a securities exchange.

9-92. (canceled)

93. A method of transferring a security in an entity, the method comprising the steps of:
operating one or more programmed processors to execute programmed instructions stored on a tangible, computer-readable medium, to consummate by a first party and a second party a transaction in the security, the first party and the second party being distinct from the entity; and
operating one or more programmed processors to execute programmed instructions stored on a tangible, computer-readable medium, to determine and pay a royalty on the transaction to the entity,
wherein said security comprises one or more fungible shares representing an ownership interest in the entity, and which shares are unrestricted as to alienation and traded on a securities exchange.

94. The method of claim 93, wherein the step of operating one or more programmed processors to pay a royalty on the transaction includes paying said royalty by at least one of the first party and the second party.

95. The method of claim 93 wherein said royalty is at least a portion of a difference between a first price at which said first party sells said security and a second price at which said second party buys said security.

96. The method of claim 95 wherein the entity does not participate in the step of operating a programmed processor to consummate the transaction.

97. The method of claim 93 wherein the first party and the second party interact directly to consummate said transaction.

98. The method of claim 93 wherein said transaction is a sale by the first entity to the second entity of said security and operating a programmed processor to consummate said sale transaction includes operating said processor to collect a purchase price payment from the second entity and deliver a selling price payment to the first entity.

99. The method of claim 93 wherein operating a computer system to consummate a transaction includes the first party having a first client and the computer system obtaining from the first client an instruction requesting the first party to purchase the security or sell the security, ant the first party is not said entity.

100. The method of claim 93 wherein operating one or more programmed processors to consummate a transaction includes operating said processor or processors to:
receive a first instruction from the first party to purchase at least one said security;
receive a second instruction from the second party to sell said at least one said security;
receive other instructions from those or other parties to purchase or sell other securities;
match the first instruction with the second instruction to execute a transaction in said at least one said security,
wherein the first party and second party are distinct from the entity.

101. The method of claim 100, wherein operating one or more programmed processors to determine and pay a royalty on the transaction to the entity includes determining if the transaction is a royalty generating transaction.

102. The method of claim 100, wherein the royalty is at least one of a percentage of a fee received by an exchange which operates the processor or processors which consummates the transaction, a portion of a fee charged by an intermediary, and a portion of an increase in value of the security since it last was purchased or sold.

103. The method of claim 102, wherein the intermediary is at least one of a market maker and a broker.

104. The method of claim 93, wherein operating one or more processors to determine and pay a royalty on the transaction to the entity includes debiting an account on behalf of the entity to collect the royalty.

105. The method of claim 104, wherein operating one or more processors to determine and pay a royalty on the transaction to the entity further comprises transferring the royalty to an account maintained on behalf of the entity.

106. A computer system for use in a process of exchanging securities, comprising:
means for consummating a transaction between a first party and a second party, in securities issued by an issuing entity distinct from the issuing entity; and
means for determining a royalty to be paid to the issuing entity because of the transaction,
wherein said security comprises one or more fungible shares representing an equity ownership interest in the entity, and which shares are unrestricted as to alienation and traded on a securities exchange.

107. The computer system of claim 106, further including means for effecting paying of the determined royalty to an account of the issuing entity.

108. The computer system of claim 106, wherein the means for consummating comprises at least one computer having at least one central processing unit, an operating system, and at least one memory storage device having stored therein a set of exchange instructions for execution by the at least one CPU, the set of exchange instructions providing, when so executed, at least one user with the ability to conduct a transaction between participants distinct from the issuing entity, the set of exchange instructions comprising:
a set of instructions constructed and arranged to receive inputs from participants distinct from the entity related to transactions involving securities; and
a set of instructions constructed and arranged to facilitate the transactions between the participants.

109. The computer system of claim 108, wherein the means for determining comprises said at least one computer having at least one central processing unit, an operating system, and at least one memory storage device, the memory storage device having stored therein a set of royalty calculation instructions for execution by the at least one CPU, the set of royalty calculation instructions constructed and arranged, when so executed, to calculate royalties owed to issuing entities of the securities involved in the transactions.

110. The computer system of claim 108, wherein the set of exchange instructions is configured to run autonomously on the computer to enable transactions to occur without the intervention of a human operator.

111. The computer system of claim 108, wherein the set of exchange instructions is configured to match buy and sell orders and to calculate the royalty to be paid to the issuing entity upon at least one of completion of the transaction and upon matching of a buy and sell order.

112. The method of claim 93, wherein the transaction involves a transfer of rights other than title in the security.
